(19) United States
(12) Patent Application Publication
(10) Pub. No.: US 2011/0033606 A1
(43) Pub. Date: Feb. 10, 2011

(54) Method for Deodorizing Collagen Peptide and Food, Beverage, or Composition Using The Same

(75) Inventors: Masanori Ito, Saitama-shi (JP); Masayuki Yugi, Saitama-shi (JP); Katsumasa Shimizu, Saitama-shi (JP); Chiharu Takamatsu, Saitama-shi (JP); Taichi Itami, Saitama-shi (JP)

Correspondence Address: BOND, SCHOENECK & KING, PLLC, ONE LINCOLN CENTER, SYRACUSE, NY, 13202-1355, US

(73) Assignee: LOTTE CO., LTD., Saitama-shi (JP)

(21) Appl. No.: 12/867,697

(22) PCT Filed: Feb. 9, 2009
(86) PCT No.: PCT/JP2009/052186

§ 371 Date: Oct. 18, 2010

(30) Foreign Application Priority Data
Feb. 13, 2008 (JP) 2008-032491

(51) Int. Cl. A23J 3/04

(52) U.S. Cl. 426/657; 426/520; 426/488

(57) ABSTRACT

A method for deodorizing collagen peptide by removing the caprylic odor of the peptide. A collagen peptide solution undergoes an initial preliminary heating and a second primary heating, after which the solution is depressurized and cooled. The resulting deodorized collagen can be used in foods, beverages, or other compositions.

### CROSS-REFERENCE TO RELATED APPLICATIONS

The present application is the United States national stage filing under 35 U.S.C. 371 of PCT Application Ser. No. PCT/JP2009/052186, filed on Feb. 9, 2009, which claims priority to JP Patent Application No. 2008-032491, filed on Feb. 13, 2008. The content of the above applications is relied upon and incorporated herein by reference in its entirety.

### BACKGROUND OF THE INVENTION

1. Field of the Invention

The present invention relates to a method for deodorizing collagen peptide whereby a collagen odor can be reduced, and to a food, a beverage or a composition using the same, in particular to the method for heating degraded collagen peptide solution, preferably followed by depressurization, and a food, a beverage or a composition using the same.

2. Description of the Related Art

Collagen is fibriform protein that exists in connective tissues of humans and animals. A great deal of collagen exists in skin, bone, tendons, blood vessel walls and the like in which the connective tissues group together and serves as a skeleton in cells. It is believed that aging of skin or hairs and diseases of bone or joints are caused by aging of collagen and compromising in collagen synthesis.

Thus, many health foods available in the market which are intended for various positive effects are characterized as containing collagen. However, collagen has a distinctive caprylic odor. Further, collagen is likely to react to acid polysaccharides or tannins often contained in foods, to precipitate, and to become clouded. Hence, it has been difficult to blend the amount of collagen expected to bring about various positive effects.

Food and beverages are known in which a collagen peptide that has been obtained by hydrolyzing or enzymatic-degrading collagen is added in order to decrease the distinctive odor and the reaction to acidic polysaccharides or tannins. However, the caprylic odor which is a distinctive odor of collagen still remains in most food and beverages including collagen peptide, thus hindering the application of collagen to food, beverages, or compositions.

To date, some methods for dealing with the unpleasant odor of collagen materials have been examined. For example, a method is disclosed in Japanese Patent Publication No. 2004-236522 to facilitate ingestion of collagen by adding a sweetener. However, this only masks the odor and does not act on the odor component.

Also, a collagen product is disclosed in Japanese Patent Publication No. 2001-009020 wherein in some phase of manufacturing of a collagen product a deodorization treatment is conducted by using an active substance which can perform cross-linking of collagen at the same duration to improve mechanical properties of the collagen. This collagen product adapts the physical property of the collagen by way of cross-linking treatment, using ozone or heat dehydration of the collagen compound obtained from marine animals, and is applied to cosmetics or medicine products.

Also, in regard to collagen peptide derived from fish, a collagen peptide is disclosed in Japanese Patent Publication No. 2003-238597 having 1.0 mass % or less of free amino acid contents and 2 ppm or less of arsenic contents in the solid content that is obtained by a reverse osmotic membrane process treating an enzymatic decomposition product of an extract of fish skin and/or fish bone. This is considered to remove chiefly a free amino acid, and also requires the reverse osmotic membrane processing. Further, other prior art attempts a pretreating process for extracting protein from body tissue of animals which immerses the ingredient in an alkaline solution, acid solution, ethanol solution, and an organic solvent or to mix salts for the purpose of removing water-soluble protein, oils and fats, odor components and so on in the ingredient.

In particular, when the ingredient is derived from aquatic animals, removal of the odor component is a serious problem. A method is disclosed in Japanese Patent Publication No. 2004-300109 wherein fish skin is treated with organic solvents such as ethanol, and pretreating it by centrifugation. Likewise, a method is disclosed in Japanese Patent Publication No. 2000-050811 of pretreating fish skin by immersing it in salt.

A method is also known in Japanese Patent Publication No. 2001-200000 wherein marine animals are used as an ingredient to conduct the refinement/concentration process by way of direct ultrafiltration. However, the pretreating process is a combination of the organic solvent processing and the salt solution processing. This requires a huge investment in building additional safety facilities for preventing the danger of ignition and explosion of the organic solvent, and in the case of collagen to be served for food, it is difficult to adopt organic solvents in consideration of the health problem no matter how slight the amount of the remaining organism. Also, a method is disclosed in Japanese Patent Publication No. H08-283665 of extracting collagen from globefish skin that is boiled down in hydrous alcoholic solution.

Further, a method for removing the collagen odor and the applied food and beverage are disclosed in Japanese Patent Publication No. 2007-159557 that can decrease a bad odor (a sulfur compound) by way of heat treatment and UHT sterilization treatment of collagen peptide and hydrous ethanol. However, each of these methods necessarily require addition of alcohols such as ethanol as an organic solvent and are not able to prevent the cost of anti-explosion equipment or allow the use of eco- and health-friendly materials.

It is disclosed in “Investigative Study on Technology of Collagen Collection from Unutilized Fishery Ingredients,” a 2005 Business Report of Kushiro Fisheries Research Institute of Hokkaido Prefecture, to collect colorless unscented gelatin by acetic acid addition and salt deposition, and to collect collagen peptide by enzymatic treatment. Also, a method for treating the collagen derived from shark skin is disclosed in “Methods of Treating Collagen from Shark Skin” by way of salting, immersion in water or lime and decalcification for deodorization. However, there are drawbacks to these methods, including unevenness and low purity of the collagen solution because some part of the solubilized collagen has a slightly different property according to the pH condition of the solubilizing solution. Also, the processes subsequent to the extraction for improved purity are complicated, and there is a problem obtaining consistent yield.

Even more, a method is disclosed in Japanese Patent Publication No. 2004-300109 for improved efficiency by controlling the conditions of alkali immersion as a pretreatment process. However, none of these methods has been able to achieve a simple and safe method for reduction of the caprylic odor distinctively inherent in the collagen peptide.

On the other hand, a method is disclosed in Japanese Patent Publication No. 2005-052106 for deodorizing the peculiar immaturity of soy beans is disclosed as a conventional method for deodorization of protein applied to health foods, wherein the first deodorization treatment comprises stirring the peeled soy beans and adding heated water vapor of 120 to 150 degrees Celsius to heat the soy beans for a short duration. A second deodorization treatment comprises adding heated water and stirring for deodorization. Also, a method is disclosed in Japanese Patent Publication No. 2007-228851 for reducing the smell by dispersing/dissolving raw soy flour into heated water at a temperature of 80 to 90 degrees Celsius (the first heating), and subsequently heating at the temperature of 95 to 140 degrees Celsius (the second heating).

However, the conventional methods to deal with the caprylic odor of the collagen peptide have never made satisfactory achievements in the simple and safe way of manufacturing the deodorized collagen peptide that is most suitable to apply to food, beverage, or any other compositions.

### BRIEF SUMMARY OF THE INVENTION

It is therefore a principal object and advantage of the present invention to provide a method for deodorizing collagen peptide whereby collagen odor can be reduced.

It is another object and advantage of the present invention to provide a food, beverage, or other composition using a method for deodorizing collagen peptide whereby collagen odor can be reduced.

Other objects and advantages of the present invention will in part be obvious, and in part appear hereinafter.

In accordance with the foregoing objects and advantages, the present invention provides a method for deodorizing collagen peptide which is unprecedentedly simple and safe for a food, a beverage or a composition, and which can completely reduce the distinctive caprylic odor of collagen peptide, and the deodorized collagen peptide, and the food, beverage or the composition containing the same.

According to a first aspect of the present invention is provided a method with the following features: (1) a method for deodorizing collagen peptide wherein collagen peptide is pre-heated after dissolution in water and is further provided with main heating; (2) the method for deodorizing wherein the preliminary heating as described in (1) is conducted at 50 to 90 degrees Celsius; (3) the method for deodorizing wherein the main heating as described in (1) is conducted at 80 to 140 degrees Celsius; (4) the method for deodorizing wherein the main heating as described in (3) is conducted for 600 to 1 seconds; (5) the method for deodorizing as described in any one of (1) to (4) wherein Brix of the collagen peptide solution is 5 to 60; (6) the method for deodorizing as described in any one of (1) to (5) wherein depressurization treatment is further conducted; (7) the collagen peptide that is deodorized by the method as described in any one of (1) to (6); and (8) food, beverage or composition that contains the collagen peptide as described in (7).

According to a second aspect of the present invention is provided a method for deodorizing collagen peptide comprising the steps of: (i) providing a collagen peptide solution; (ii) heating the provided collagen peptide solution at a first temperature for a first predetermined length of time; and (iii) heating the collage peptide solution at a second temperature for a second predetermined length of time, where the second temperature is higher than the first temperature. In one embodiment, the first temperature is between 50 and 90 degrees Celsius, and the second temperature is between 80 and 140 degrees Celsius.

According to a third aspect of the present invention is provided a method for deodorizing collagen peptide comprising the steps of: (i) providing a collagen peptide solution; (ii) heating the provided collagen peptide solution at a first temperature for a first predetermined length of time; (iii) heating the collage peptide solution at a second temperature for a second predetermined length of time, where the second temperature is higher than the first temperature; (iv) removing the water vapor created by the second heating step; and (v) optionally cooling the deodorized collagen peptide solution.

According to a fourth aspect of the present invention is provided a deodorized collagen peptide prepared by a method comprising the steps of: (i) providing a collagen peptide solution; (ii) heating the provided collagen peptide solution at a first temperature for a first predetermined length of time; and (iii) heating the collage peptide solution at a second temperature for a second predetermined length of time, where the second temperature is higher than the first temperature.

According to a fifth aspect of the present invention is provided a composition containing a deodorized collagen peptide prepared by a method comprising the steps of: (i) providing a collagen peptide solution; (ii) heating the provided collagen peptide solution at a first temperature for a first predetermined length of time; and (iii) heating the collage peptide solution at a second temperature for a second predetermined length of time, where the second temperature is higher than the first temperature.

### BRIEF DESCRIPTION OF THE SEVERAL VIEWS OF THE DRAWING(S)

The present invention will be more fully understood and appreciated by reading the following Detailed Description in conjunction with the accompanying drawings, in which:

FIG. 1 is a schematic diagram of a method for deodorizing collagen peptide according to one embodiment of the present invention.

### DETAILED DESCRIPTION OF THE INVENTION

After committed studies to solve the above problem, it was discovered that a remarkable deodorizing effect of reducing the distinctive odor inherent in collagen is achieved using a collagen peptide prepared by dissolving a degraded collagen peptide in water, heating it, and further heating the solution at a higher temperature.

The present invention is characterized by a method for deodorizing collagen peptide, the method comprising: heating degraded collagen peptide solution (preliminary heating); further heating the solution at a higher temperature (main heating); and preferably further depressurization. The method is characterized by the treated collagen peptide and a food, a beverage, or a composition containing the same.

Collagen peptide is obtained by immersing skin and joint of animals such as pig, cow, or hen, as well as the scale and skin of fish into an acid or an alkaline liquid, obtaining gelatin by extraction, and then degrading the obtained gelatin by way of enzymatic treatment using, for example, proteolytic enzymes. Typically, the peptide is enzymatically degraded using, for example, proteolytic enzymes, and after deactivation thereof, the plate heating is conducted as sterilization treatment. In the present invention, however, the deodorization method is conducted instead of this sterilization treatment process, and can thus obtain the powder of collagen peptide by spray drying and so on.

The step of preliminary heating refers to a process of heating a collagen peptide aqueous solution at 50 to 90 degrees Celsius. It is the main object of this process to perform a precise temperature control of the main heating, whereby deodorized collagen peptide can be obtained with stable quality.

A problem of rapid heating to a high temperature all at once is that the great difference of temperature generates unstable thermal history which prevents constant treatment temperature, possibly leading to an inability to stably obtain the expected deodorizing effect. Hence, it is preferred to conduct the preliminary heating at 90 degrees Celsius or less from the viewpoint of stability in quality.

The duration for preliminary heating is several seconds because it is usually performed continuously, but length of duration can be appropriately changed from the viewpoint of placement of the fabrication plant.

The step of main heating in the present invention refers to a process of heating at 80 to 140 degrees Celsius. It is the main purpose of this process to make it easy to splash odor by blowing high temperature water vapor against the odor component derived from collagen peptide ingredient. An advantageous effect is that sterilization is carried out at the same time.

As stated above, the deodorization method of the present invention is intended to produce collagen peptide having reduced caprylic odor as well as the production of a food, beverage, or composition containing the same. In order to reduce this caprylic odor, it is necessary to make it easy to remove the odor component contained in collagen peptide ingredient by blowing the water vapor. However, when the temperature of the main heating is set to 80 degrees Celsius, the quantity of the blow is not sufficient for complete removal. It is thus preferable to heat at a higher temperature, namely 90 degrees Celsius or higher, to make it easy to blow off the odor component completely. Meanwhile, excessive heating would cause denaturation of the contained component within the collagen peptide ingredient, causing a burnt odor, which is not desirable.

Hence, in the method of the present invention, a further heating is preferable to maintain the temperature not less than 100 and not exceeding 140 degrees Celsius such that any odor component from the collagen peptide solution contained in the water solution is removed by means of the pressure force of the water vapor while preventing denaturation of the component.

Additionally, the main heating is effective from the viewpoint of sterilization treatment. The relationship between the temperature and the duration of heating should be determined in light of the pressurization of the water vapor for deodorization and the appropriate temperature and duration for prevention of denaturation of the component; the above-mentioned conditions necessary for deodorization and denaturation prevention were fully met with the effect of the sterilization at the same duration. In consideration of the deodorization and sterilization, the main heating is preferably carried out at 80 to 140 degrees Celsius and for 600 to 1 seconds. More preferably, deodorization and sterilization are optimally performed with the main heating at the temperature of 110 to 140 degrees Celsius for a duration in the range of 60 to 4 seconds.

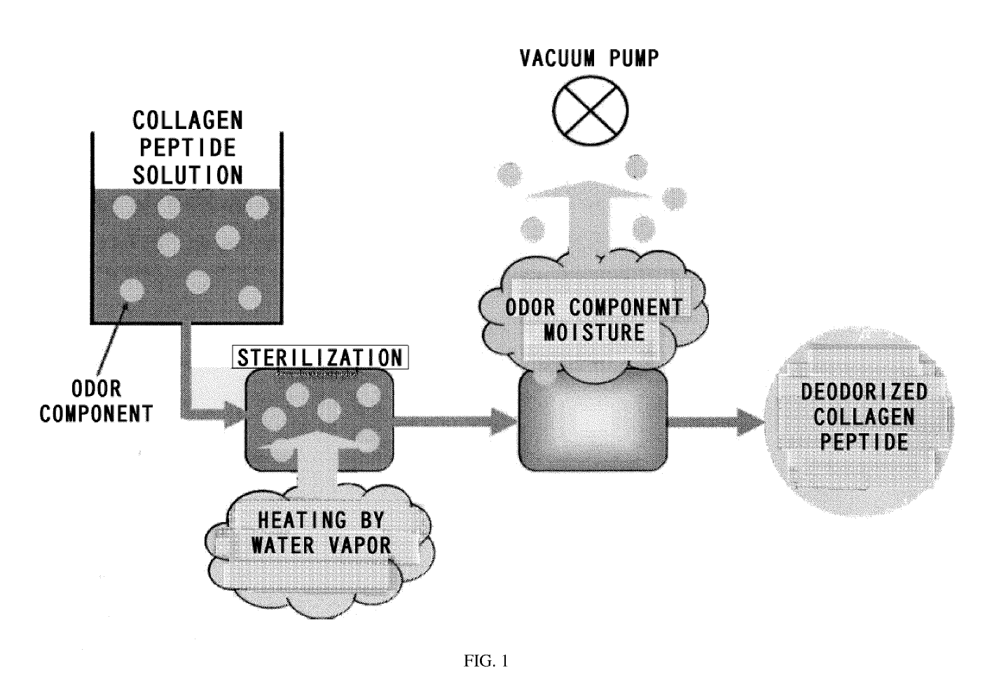

For more complete deodorization, depressurization treatment may further be conducted after the main heating as shown in FIG. 1. In this treatment, the water vapor that has been blown during the main heating can be evaporated, for example, by using vacuum pumps. A more complete deodorization can thus be expected since the odor component is removed when this moisture content is evaporated.

The deodorized collagen peptide produced in this manner can be used for drinking directly, or for drinking after mixing with other ingredients. In addition, since collagen peptide can be applied to a variety of foods, beverages, and other compositions, the method can provide a food, beverage, or other composition that is completely free of the caprylic odor derived from collagen. Collagen peptide can be positioned as a health food and so on. For use as a functional food, the collagen peptide, after being added some proper agent, can be prepared in the form of, for example, a small particle, granule, tablet, capsule, soft capsule and paste, or by way of other conventional means in which collagen peptide is suitable as a food. This food and beverage may be directly served for consumption, or may also be used by adding to various kinds of food (e.g. ham, sausage, boiled fish paste, a tubular fish meat, bread, butter, powdered milk, cake), or by applying to beverages such as water, alcoholic beverages, fruit juice, milk and soft beverages. The amount of collagen peptide to be blended with these food and beverage is not particularly limited, but preferably 1 to 95 weight % in anticipation of the positive effects.

Now the best mode for carrying out the present invention will be explained in detailed with reference to the examples. These examples, however, do limit the scope of the present invention.

### EXAMPLES

Examined below is the relationship of the collagen peptide solubility and the temperatures when the collagen peptide ingredient is dispersed/dissolved in water.

### Experimental Example 1

A collagen hydrolysate of the degraded collagen peptide solution derived from pigs was prepared to be 30 or 45 Brix using purified water. After first heating the obtained collagen peptide solution to 80 degrees Celsius, the solution was further heated to 110, 120, 130, and/or 140 degrees Celsius by blowing steam (the main heating step), and was then depressurized and cooled after retaining for 30 seconds, whereby a processed solution of collagen peptide having the same Brix level as that before treatment is obtained.

The treated collagen peptide solution was diluted to be 5%, and the diluted solution underwent an organoleptic evaluation by five human subjects for the collagen odor on the basis of five scales ranging from − (worse than when untreated) to +++ (remarkably better than when untreated), and the heated flavor on the basis of five scales ranging from + (better than when untreated) to −−− (remarkably worse than when untreated). The results of the collagen odor are shown in Table 1, in which the duration of the main heating varies from 110 degrees Celsius to 140 degrees Celsius, all applied for 30 seconds. Shown in Table 2 are the results of the heated flavor tests, in which heated flavor refers to the so-called burnt odor. In Table 2, the collagen peptide solution underwent main heating at a temperature ranging from 110 degrees Celsius to 140 degrees Celsius, all applied for 30 seconds.

TABLE 1
Results of Organoleptic Evaluation of the Odor of a Collagen
Peptide Solution Treated at Different Temperatures.

| | |
|---|---|
| Brix of Collagen | Temperature of Main Heating |

| Peptide Solution | 110° C. | 120° C. | 130° C. | 140° C. |
|---|---|---|---|---|
| 30 | ++ | ++ | ++ | +++ |
| 45 | ++ | ++ | +++ | +++ |

−: worse than when untreated
+/−: same as when untreated
+: slightly better than when untreated
++: better than when untreated
+++: remarkably better than when untreated

TABLE 2
Results of Organoleptic Evaluation of the Taste of a Collagen
Peptide Solution Treated at Different Temperatures.

| | |
|---|---|
| Brix of Collagen | Temperature of Main Heating |

| Peptide Solution | 110° C. | 120° C. | 130° C. | 140° C. |
|---|---|---|---|---|
| 30 | +/− | +/− | − | −− |
| 45 | − | − | −− | −−− |

+: better than when untreated
+/−: same as when untreated
−: slightly worse than when untreated
−−: worse than when untreated
−−−: remarkably worse than when untreated

According to the results, when the sample was pre-heated and then heated at 110 to 140 degrees Celsius for 30 seconds during the main heating treatment, the collagen odor of the collagen peptide solutions when the Brix is 30 and 45 was favorably reduced at any of the temperature in comparison with the odor prior to the deodorization treatment. On the other hand, with respect to the heated flavor when Brix was 30, only the samples heated at the main heating temperature of 110 and 120 degrees Celsius showed the results similar to those prior to the deodorization treatment. Hence, it was found that Brix of the collagen peptide solution preferable for the deodorization of the collagen peptide of the present invention was 30 to 45 at the main heating temperature of 110 to 140 degrees Celsius. Further, it was found that the most suitable condition of the collagen peptide deodorization processing method for both collagen odor and heated flavor was with a main heating temperature of 110 and 120 degrees Celsius for 30 seconds and when the Brix of the collagen peptide solution was 30.

Examined below is the relationship between the duration of the main heating and the main heating temperature.

### Experimental Example 2

Brix of the degraded collagen peptide solution derived from pigs was prepared to be 30 using purified water. After heating the obtained collagen peptide solution to 80 degrees Celsius, the solution was further heated under the conditions of 110, 120, 130, or 140 degrees Celsius by blowing steam (the main heating step), and was then depressurized and cooled after retaining at the selected temperature condition for 4, 15, 30 or 60 seconds, whereby a processed solution of collagen peptide having the same Brix level as that before treatment was obtained.

The treated collagen peptide solution was diluted to be 5%, and the diluted solution underwent an organoleptic evaluation by five human subjects for the collagen odor on the basis of five scales ranging from − (worse than when untreated) to +++ (remarkably better than when untreated), and the heated flavor on the basis of five scales ranging from + (better than when untreated) to −−− (remarkably worse than when untreated). The results of the collagen odor are shown in Table 3, and the results of the heated flavor are shown in Table 4.

TABLE 3
Results of Organoleptic Evaluation of the Odor
of a Collagen Peptide Solution Treated at Different
Temperatures For Different Lengths of Time.

| | |
|---|---|
| Duration of Main | Temperature of Main Heating |

| Heating | 110° C. | 120° C. | 130° C. | 140° C. |
|---|---|---|---|---|
| 4 s | | +/− | +/− | + |
| 15 s | +/− | +/− | + | ++ |
| 30 s | ++ | ++ | ++ | +++ |
| 60 s | ++ | ++ | ++ | +++ |

−: worse than when untreated
+/−: same as when untreated
+: slightly better than when untreated
++: better than when untreated
+++: remarkably better than when untreated

TABLE 4
Results of Organoleptic Evaluation of the Taste
of a Collagen Peptide Solution Treated at Different
Temperatures For Different Lengths of Time.

| | |
|---|---|
| Duration of Main | Temperature of Main Heating |

| Heating | 110° C. | 120° C. | 130° C. | 140° C. |
|---|---|---|---|---|
| 4 s | | +/− | +/− | +/− |
| 15 s | +/− | +/− | +/− | − |
| 30 s | +/− | +/− | − | −− |
| 60 s | +/− | − | −− | −−− |

+: better than when untreated
+/−: same as when untreated
−: slightly worse than when untreated
−−: worse than when untreated
−−−: remarkably worse than when untreated

These results show that when the Brix of the collagen peptide solution was 30, and when the main heating was conducted at 110 degrees Celsius, both the collagen odor and the heated flavor became, in 15 to 60 seconds, equal to, or better than, those when untreated; when the main heating was conducted at 120 to 140 degrees Celsius, the collagen odor ameliorated in 4 to 60 seconds. In addition, the heated flavor became similar to that when untreated: in 4 to 30 seconds at the main heating temperature 120 degrees Celsius; 4 to 15 seconds at 130 degrees Celsius, and 4 seconds at 140 degrees Celsius.

Accordingly, with respect both to the collagen odor and to the heated flavor, the duration and temperature of the main heating for the deodorization of the collagen peptide of Brix 30 in the collagen peptide solution of the present invention were preferably 30 to 60 seconds at 110 degrees Celsius, 30 seconds at 120 degrees Celsius, 15 seconds at 130 degrees Celsius, 4 seconds at 140 degrees Celsius; most preferably 110 and 120 degrees Celsius for 30-second heating duration and 110 degrees Celsius for 60-second heating duration.

Examples of the present invention will now be described below in detail.

### Example 1

Collagen peptide solution (Brix 30) was heated to 80 degrees Celsius using a plate-type heat exchanger, and was further heated to 120 degrees Celsius in a short duration by mixing with heated high-pressure water vapor (150 degrees Celsius, 0.4 MPa), and was retained at this temperature for 15 seconds. The water vapor containing the odor component was evaporated under reduced pressure (gauge pressure −0.05 MPa) using a vacuum pump, and was immediately cooled off with the plate heat exchanger, such that the deodorized collagen peptide solution was obtained. Meanwhile, the steam injection for mixing with heated high-pressure water vapor can be conducted in a typically conventional method, thus there is no need to use a special device or technique.

Following are the examples of the deodorized collagen peptide which was obtained from the above-mentioned test results, and which was then applied to food, beverage or composition. The inventive product (collagen peptide) prepared by way of the method shown in the Experimental Examples was used to manufacture a beverage, powdered formulation, tablet, chewing gum, candy, and tablet candy in accordance with the following formulation.

### Example 2

### Formulation of Beverage

Collagen peptide, 5.0 parts by weight; High-fructose corn syrup, 8.0 parts by weight; Sugar, 4.0 parts by weight; Fragrant material, 0.5 parts by weight; and Vitamin C, 5.0 parts by weight. Having been adjusted to pH 3.8 using acidulant, the sample was rendered 100 parts by volume using purified water.

### Example 3

### Formulation of Beverage

Collagen peptide, 5.0 parts by weight; Sucralose, 0.005 parts by weight; Stevioside, 0.008 parts by weight; Rebaudioside, 0.008 parts by weight; Acesulfame potassium, 0.01 parts by weight; Peach fragrant material, 0.5 parts by weight; and Vitamin C, 0.5 parts by weight. Having been adjusted to pH 3.8 using acidulant, it was rendered 100 parts by volume using purified water.

### Example 4

### Formulation of Beverage

Collagen peptide, 5.0 parts by weight; Acidic milk beverage, 5.0 parts by weight; High-fructose corn syrup, 10.0 parts by weight; Fragrant material, 0.5 parts by weight; and Vitamin C, 0.5 parts by weight. Having been adjusted to pH 3.8 using acidulant, the sample was rendered 100 parts by volume using purified water.

### Example 5

### Formulation of Beverage

Collagen peptide, 5.0 parts by weight; High-fructose corn syrup, 10.0 parts by weight; Honey, 5.0 parts by weight; Fragrant material, 0.5 parts by weight; and Vitamin C, 5.0 parts by weight. Having been adjusted to pH 3.8 using acidulant, the sample was rendered 100 parts by volume using purified water.

### Example 6

### Formulation of Jelly Beverage

Collagen peptide, 5.0 parts by weight; Sucralose, 0.005 parts by weight; Stevioside, 0.008 parts by weight; Rebaudioside, 0.008 parts by weight; Acesulfame potassium, 0.01 parts by weight; Peach fragrant material, 0.5 parts by weight; Vitamin C, 5.0 parts by weight; and Gelling agent, 0.5 parts by weight. Having been adjusted to pH 3.8 using acidulant, the sample was rendered 100 parts by volume using purified water.

### Example 7

### Formulation of Jelly Beverage

Collagen peptide, 5.0 parts by weight; High-fructose corn syrup, 8.0 parts by weight; Sugar, 4.0 parts by weight; Fragrant material, 0.5 parts by weight; Vitamin C, 5.0 parts by weight; and Gelling agent, 0.5 parts by weight. Having been adjusted to pH 3.8 using acidulant, the sample was rendered 100 parts by volume using purified water.

### Example 8

### Formulation of Coffee Beverage

Collagen peptide, 5.0 parts by weight; Coffee extract, 5.0 parts by weight; Sugar, 4.0 parts by weight; Fragrant material, 0.5 parts by weight; and Vitamin C, 5.0 parts by weight. Having been adjusted to pH 6.5 using sodium bicarbonate, the sample was rendered 100 parts by volume with purified water.

### Example 9

### Formulation of Green Tea Beverage

Collagen peptide, 5.0 parts by weight; Green tea extract, 10.0 parts by weight; Fragrant material, 0.5 parts by weight; and Vitamin C, 5.0 parts by weight. Having been adjusted to pH 6.5 using sodium bicarbonate, the sample was rendered 100 parts by volume with purified water.

### Example 10

### Formulation of Powdered Formulation

Collagen peptide, 90.0 parts by weight; Lactose, 5.0 parts by weight; Dextrin, 4.0 parts by weight; and Vitamin C, 1.0 parts by weight.

### Example 11

### Formulation of the Tablet

Collagen peptide, 5.0 parts by weight; D-mannitol, 40.0 parts by weight; Lactose, 40.0 parts by weight; Crystalline cellulose, 10.0 parts by weight; and Hydroxypropyl cellulose, 5.0 parts by weight.

### Example 12

### Formulation of Chewing Gum

Collagen peptide, 5.0 parts by weight; Gum base, 20.0 parts by weight; Sugar, 55.0 parts by weight; Glucose, 10.5 parts by weight; Syrup, 9.0 parts by weight; and Fragrant material, 0.5 parts by weight.

### Example 13

### Formulation of Candy

Collagen peptide, 5.0 parts by weight; Sugar, 50.0 parts by weight; Syrup, 29.5 parts by weight; Fragrant material, 0.5 parts by weight; and Water, 15.0 parts by weight.

### Example 14

### Formulation of Tablet Candy

Collagen peptide, 5.0 parts by weight; Sugar, 73.5 parts by weight; Glucose, 17.0 parts by weight; Sucrose fatty acid ester, 0.2 parts by weight; Fragrant material, 0.2 parts by weight; and Water, 4.1 parts by weight.

### Example 15

### Formulation of Gummy Jelly

Collagen peptide, 5.0 parts by weight; Gelatin, 55.0 parts by weight; Syrup, 23.0 parts by weight; Sugar, 8.5 parts by weight; Vegetable fat and oil, 4.5 parts by weight; Mannitol, 40.0 parts by weight; and Lemon fruit juice, 1.0 parts by weight.

### Example 16

### Formulation of Chocolate

Collagen peptide, 5.0 parts by weight; Powder sugar, 36.8 parts by weight; Cacao bitter, 20.0 parts by weight; Dry whole milk, 20.0 parts by weight; Cacao butter, 17.0 parts by weight; Mannitol, 1.0 parts by weight; and Fragrant material, 0.2 parts by weight.

### Example 17

### Formulation of Sherbet

Collagen peptide, 5.0 parts by weight; Orange fruit juice, 25.0 parts by weight; Sugar, 23.0 parts by weight; Egg white, 9.0 parts by weight; and Water, 38.0 parts by weight.

Having been described based on the above-mentioned examples, the present invention can be carried out without being limited to the mode for carrying out the present invention at all.

### INDUSTRIAL APPLICABILITY

The present invention makes it possible to provide a method for deodorizing collagen peptide which can completely reduce the distinctive caprylic odor of collagen peptide, as well as a deodorized collagen peptide and the food, beverage, or composition containing the same, whereby new applications of collagen peptide are provided.

An unprecedentedly complete deodorization is made possible by applying to collagen peptide a heating process using water vapor and preferably, a decompression process; in addition, the present invention is very useful in that stabilization of the quality of the collagen peptide and production of collagen peptide can be streamlined by omitting the sterilization process; furthermore, the present invention is extremely useful because it enables collagen peptide to be applied to expanded scope of food, beverage or composition.

Although the present invention has been described in connection with a preferred embodiment, it should be understood that modifications, alterations, and additions can be made to the invention without departing from the scope of the invention as defined by the claims.

What is claimed is:

1. A method for deodorizing collagen peptide, the method comprising the steps of:
providing a collagen peptide solution;
heating said collagen peptide solution at a first temperature for a first predetermined length of time; and
heating said collage peptide solution at a second temperature for a second predetermined length of time, wherein said second temperature is higher than said first temperature.

2. The method of claim 1, wherein said first temperature is between 50 and 90 degrees Celsius.

3. The method of claim 1, wherein said second temperature is between 80 and 140 degrees Celsius.

4. The method of claim 1, wherein said second predetermined length of time is between 1 and 600 seconds.

5. The method of claim 1, wherein said collagen peptide solution is between 5 and 60 Brix.

6. The method of claim 1, further comprising the step of removing the water vapor created by the second heating step.

7. The method of claim 1, further comprising the step of cooling the deodorized collagen peptide solution.

8. A deodorized collagen peptide prepared by a method comprising the steps of:
providing a collagen peptide solution;
heating said collagen peptide solution at a first temperature for a first predetermined length of time; and
heating said collage peptide solution at a second temperature for a second predetermined length of time, wherein said second temperature is higher than said first temperature.

9. The deodorized collagen peptide of claim 8, wherein said first temperature is between 50 and 90 degrees Celsius.

10. The deodorized collagen peptide of claim 8, wherein said second temperature is between 80 and 140 degrees Celsius.

11. The deodorized collagen peptide of claim 8, wherein said second predetermined length of time is between 1 and 600 seconds.

12. The deodorized collagen peptide of claim 8, wherein said method further comprises the step of removing the water vapor created by the second heating step.

13. The deodorized collagen peptide of claim 8, wherein said method further comprises the step of cooling the deodorized collagen peptide solution.

14. A composition containing a deodorized collagen peptide prepared by a method comprising the steps of:
providing a collagen peptide solution;
heating said collagen peptide solution at a first temperature for a first predetermined length of time; and
heating said collage peptide solution at a second temperature for a second predetermined length of time, wherein said second temperature is higher than said first temperature.

15. The composition of claim 14, wherein said first temperature is between 50 and 90 degrees Celsius.

16. The composition of claim 14, wherein said second temperature is between 80 and 140 degrees Celsius.

17. The composition of claim 14, wherein said second predetermined length of time is between 1 and 600 seconds.

18. The composition of claim 14, wherein said method further comprises the step of removing the water vapor created by the second heating step.

19. The composition of claim 14, wherein said method further comprises the step of cooling the deodorized collagen peptide solution.
